(19) United States
(12) Patent Application Publication
(10) Pub. No.: US 2019/0087184 A1
(43) Pub. Date: Mar. 21, 2019

(54) SELECT IN-ORDER INSTRUCTION PICK USING AN OUT OF ORDER INSTRUCTION PICKER

(71) Applicant: QUALCOMM Incorporated, San Diego, CA (US)

(72) Inventors: Vignyan Reddy KOTHINTI NARESH, Morrisville, NC (US); Lisa HSU, Durham, NC (US); Vinay MURTHY, Poway, CA (US); Anil KRISHNA, Cary, NC (US); Gregory WRIGHT, III, Chapel Hill, NC (US)

(21) Appl. No.: 15/706,540

(22) Filed: Sep. 15, 2017

(51) Int. Cl. G06F 9/30; G06F 9/38

(52) U.S. Cl. CPC G06F 9/30036; G06F 9/30094; H04L 45/06; G06F 9/3855; G06F 2212/682; G06F 9/3836

(57) ABSTRACT

Systems and methods are directed to instruction execution in a computer system having an out of order instruction picker, which are typically used in computing systems capable of executing multiple instructions in parallel. Such systems are typically block based and multiple instructions are grouped in execution units such as Reservation Station (RSV) Arrays. If an event, such as an exception, page fault, or similar event occurs, the block may have to be swapped out, that is removed from execution, until the event clears. Typically when the event clears the block is brought back to be executed, but typically will be assigned a different RSV Array and re-executed from the beginning of the block. Tagging instructions that may cause such events and then untagging them, by resetting the tag, once they have executed can eliminate much of the typical unnecessary re-execution of instructions.

### FIELD OF DISCLOSURE

Disclosed aspects are directed to processing systems which process multiple instructions in parallel. More specifically, exemplary aspects are directed to maintaining program order in processing systems which execute multiple instructions, which may be executed out of program order.

### BACKGROUND

Modern processors commonly execute instructions in non-program order in order to speed execution and increase instruction parallelism. There are, however, some instructions which need to be executed in program order, which can be a problem if the program is being divided into chunks to execute in parallel. Typically instructions are dispatched to be executed in chunks called blocks. A block is a portion of code that has one entrance and one exit.

Sometimes blocks may stall waiting for page faults, waiting for resources, or the like. If the block stalls it may be removed from memory, e.g., during a pipeline flush. However many instructions in the block may be already executed, but since the block is removed those instructions may be re-executed when the block is brought back into memory to execute. It may be hard to know which instructions have already been executed since multiple instructions may be executed in parallel.

As an illustrative and non-limiting example consider the Cascade ISA (Instruction Set Architecture). The Cascade ISA treats blocks of code as atomic, that is either all the instructions in the block are considered to have been executed or none of the instructions in a block are considered to have been executed. Overhead may be caused when a block of code encounters an exception and its execution must be delayed (e.g. swapped out of memory, flushed, or simply delayed as not ready to execute). Once the cause of the execution delay is handled, the block of code containing the exception may once again try to be executed. Since the block is atomic however none of the instructions will be considered to have been executed. Accordingly the instructions that were executed before the exception are re-executed as the Cascade ISA (and other block based ISAs) do not provide a mechanism to restart execution within the block. The block is considered not executed and executions starts at the beginning of the block, no matter how much of the block (less than all of it) had been executed. This block level execution granularity prevents the restarting of the block anywhere but at the beginning. Consider how wasteful this may be if the instruction causing the exception is near the end of the block and the majority of the instructions already have executed only to be re-executed after the exception is cleared.

Accordingly there is a need in the art for ways to execute instructions in program order, with instruction granularity, in processors utilizing instruction parallelism, such as those having the exemplary Cascade ISA, that execute instructions in parallel.

### SUMMARY

Exemplary aspects of the invention are directed to systems and method for maintaining program order in block based processing systems which execute instructions out of order. For example, disclosed systems and methods are directed to a method to serialize selection of a select group of instructions using an out of order instruction picker. The method includes tagging the instructions as belonging to the select group of instructions, identifying the program order of the instructions belonging to the select group of instructions, and executing the instructions belonging to the select group in program order.

Other aspects of the invention include an apparatus for executing Sequential Instructions. The apparatus includes a decoder that identifies a select group of instructions and tags them; a Reservation Station (RSV) that receives tagged instructions and places them in arrays for execution; a multiplexer for receiving complex instructions from the arrays within the reservation station and directing them to an appropriate Functional Unit; and a multiplexer that receives a result from the appropriate Functional Unit and directs it to the appropriate array within the RSV.

Further aspects of the invention include a method for executing Sequential Instructions, which includes identifying a select group of instructions, tagging each of the select group of instructions, receiving the tagged instructions in a reservation station (RSV), placing the tagged instruction in arrays for execution, receiving complex instructions from the arrays within the reservation station in a multiplexer, directing the complex instructions to an appropriate Functional Unit, receiving a result from the appropriate Functional Unit in a multiplexer, and directing the result to the appropriate array within the RSV.

Aspects of the invention also include a method of skipping the execution of a Sequential Instruction. The method includes detecting a Sequential Instruction in a branch not taken of computer code; and untagging the Sequential Instruction.

Aspects of the invention also include a method for detecting an oldest ready instruction. The method includes detecting an oldest Sequential Instruction, determining that the oldest ready instruction is younger that the oldest Sequential Instruction, and allowing the oldest Sequential Instruction to be skipped.

Aspects of the invention also include a method of skipping the execution of a Sequential Instruction. The method includes detecting an oldest executing instruction, detecting an oldest Sequential Instruction, determining that the oldest executing instruction is younger that the oldest Sequential Instruction; and allowing the oldest Sequential Instruction to be skipped.

Aspects of the invention also include a method of skipping the execution of a Sequential Instruction. The method includes, keeping an execution count of the number of executing instructions within an RSV Array, determining the oldest Sequential Instruction in the RSV Array, determining the oldest ready instruction in the RSV Array, determining if the execution count of all instructions older than the oldest Sequential Instruction is zero and the oldest ready instruction is younger than the oldest Sequential Instruction; and allowing the Sequential Instruction to be skipped if the execution count of all instructions older than the oldest Sequential Instruction is zero and the oldest ready instruction is younger than the oldest Sequential Instruction.

### BRIEF DESCRIPTION OF THE DRAWINGS

The accompanying drawings are presented to aid in the description of aspects of the invention and are provided solely for illustration of the aspects and not limitation thereof.

FIG. 1 is a graphical illustration of a computer program and instructions from the program allocated to RSV (reservation Station) arrays.

FIG. 2 is a graphic illustration of an exemplary processing system illustrating aspects of the inventive concepts disclosed herein.

FIG. 3 is a graphic diagram illustrating different aspects of RSV arrays, which may be used in solving the “skip over instruction” problem according to aspects of the inventive concepts herein.

FIG. 4 is a graphic diagram illustrating an implementation of an RSV array according to aspects of the inventive concepts herein.

FIG. 5 is a flow chart illustrating a “skip over instruction” problem.

FIG. 6 is a graphical illustration of a processor system, which may advantageously employ the teachings herein to improve performance.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

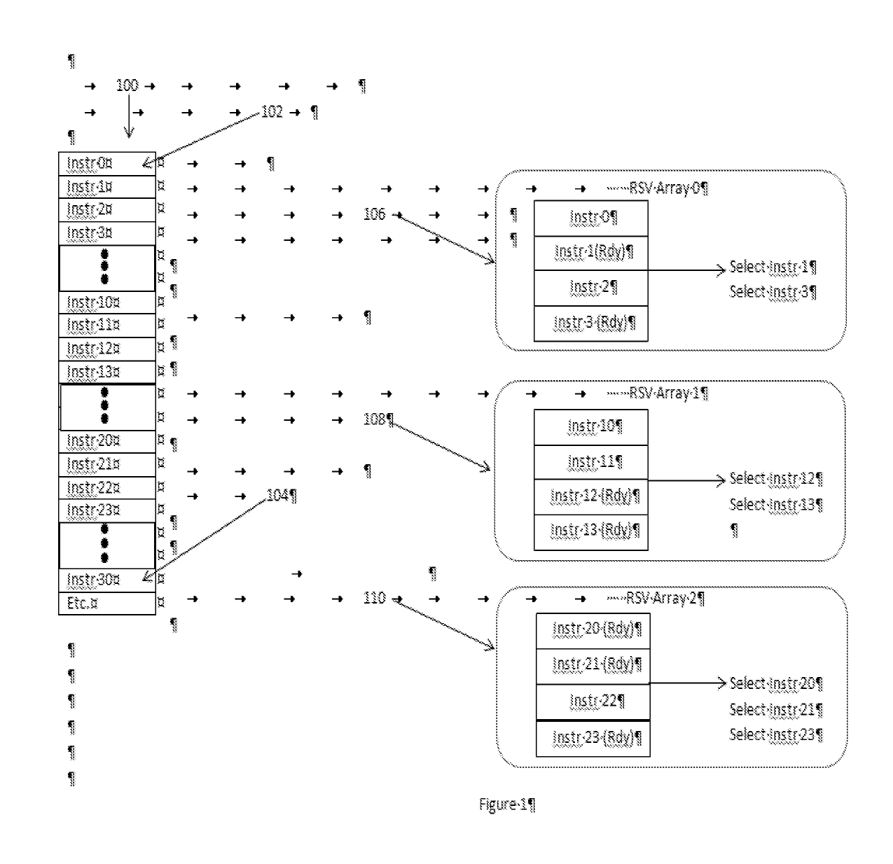

FIG. 1 is a graphical illustration of a computer program and instructions from the program allocated to RSV (Reservation Station) arrays.

A computer program 100 is a series of instructions, for example as shown at 102 (Instr 0) and 104 (Instr 30). The instructions illustrated are labeled Instr 0 through Instr 30. In order to execute the instructions they are allocated to RSV Arrays, such as those illustrated at 106, 108 and 110. The instructions may be allocated to the different RSV arrays either in order or out of order, however the instructions within each RSV array will be in program order. In the illustration in FIG. 1 the instructions are illustratively allocated to RSV Array 0, RSV Array 1 and RSV Array 2 in program order, with the oldest instruction in RSV Array 0 and the youngest instructions in RSV Array 2, though they need not be. The instructions allocated to RSV Array 0 could equivalently be allocated to RSV Array 1, RSV Array 2, or any other RSV Array. Similarly the instructions in RSV Array 1 and RSV array 2 could be equivalently allocated to any other RSV Array.

Instructions are selected from RSV Arrays to execute when they are ready. For example in RSV Array 0 Instr 1, and Instr 3 are ready to execute. Likewise, in RSV Array 1 Instr 12, and Inst 13 are ready to execute. Similarly, in RSV Array 2, Instr 20, Instr 21, and Instr 23 are ready to execute.

Instructions can be picked for execution as they become ready for execution within each RSV array, ignoring the program order, that is ready instruction 20 may be selected, for example, from RSV Array 2, to be executed before Instruction 1 from RSV Array 0 or instruction 12 from RSV Array 1 are executed. This is typically referred to as out-of-order execution. Additionally, for example, when the instructions in FIG. 1 are picked to execute Instr 1, Instr 12, and Instr 20 may be picked to execute in the same instruction cycle, even though Instr 12 is younger than Instr 1, and Instr 20 is younger than both Instr 1 and Instr 12.

Ready instructions are dispatched for execution in each RSV array, oldest ready instruction first. Ready instructions in other RSV arrays may execute even if they are younger ready instructions in other RSV arrays

The techniques presented in this invention ensure that selected instructions within an RSV Array go in the program order, in effect preventing execution of younger ready instruction within the RSV Array when an older instruction has not executed. Note that instructions in the other blocks, either older or younger, can proceed to execute instructions in out-of-order fashion. Ready instructions within an RSV Array execute in order, however they may actually be out of order when compared to instructions in other RSV arrays.

Consider the example in FIG. 1. If in RSV Array 0 Instr 2 and Instr 3, as instructions that need to execute in program order, then Instr 3's execution needs to be delayed till Instr 2 is ready and has some confirmation that it will execute before dispatching Instr 3 for execution. Meanwhile, Instrs 12, 13, 20, 21, 23 can all be picked in the other blocks, to execute even though they are younger than Instr 2 and Instr 3. Within RSV array 0, Instr 1 can be picked for execution, but Instr 3 needs to wait for Instr 2 to be picked for execution.

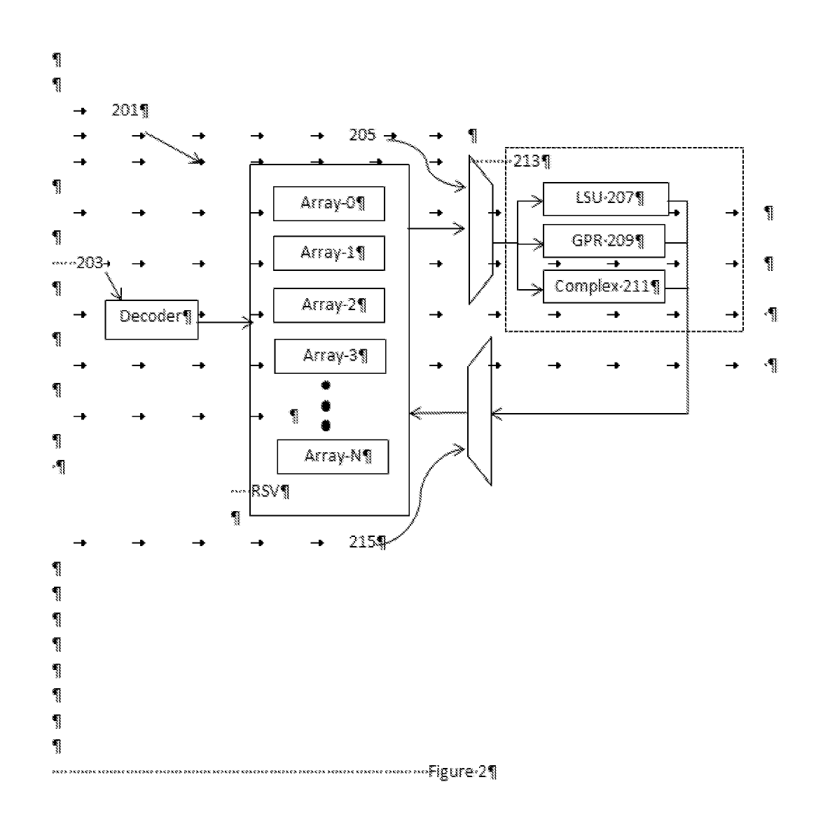

FIG. 2 is a graphic illustration of an exemplary processing system illustrating aspects of the inventive concepts disclosed herein. In FIG. 2, a portion of a computing system is illustrated at 201. A decoder 203 examines and classifies instructions according to their op codes and identifies and tags instructions that need to execute in sequential order, as previously discussed. For the purposes of our discussion the instructions are tagged with a value of S=1 if they are Sequential Instructions and are tagged with a value of S=0 if they are not. After the instructions are tagged, they are then sent to RSV arrays 105-113, illustrated as Array-0, Array-1, Array-2, Array-3 through Array-N in FIG. 2, pending execution of the instructions. Each RSV Array (e.g., 105-113) can hold a set number of instructions that can vary depending on the computer architecture and implementation needs. For example the Cascade Architecture specifies a maximum of 128 instructions per RSV Array.

Each RSV Array will typically have an ALU (Arithmetic Logic Unit) which can perform simple operations such as add and shift. The more complex operations and operations which cannot be performed within the RSV Arrays 105-113 are offloaded to a separate unit 213, which may contain various computing related functions (Functional Units, e.g. 207, 209 and 211). In FIG. 2 this offloading is exemplarily illustrated. The RSV Arrays 105-113 are coupled to a multiplexer (mux) 205, which can receive such operations to be offloaded from any of the RSV Arrays 105-113 and direct them to the proper Functional Unit, e.g. 207, 209 or 211, in the separate unit 213. In the example illustrated in FIG. 2, the multiplexer (mux) 205 may direct such offloaded operations to a LSU (Load Store Unit) 207 which may receive load values that an executing RSV Array instruction will need, and it may store the output from the RSV Array instruction to a proper storage place. The mux 205 may also direct a value to or from a GPR (General Processor Register) 209. More complex operations may be directed to Complex operation unit 211. The Complex operation unit 211 may perform such tasks as multiply, divide or floating point operations.

Once the offloaded task is complete, a signal may be sent to the appropriate RSV Array (e.g., 105-113), via mux 215, that the operation was completed, and if the completed instruction was classified as an S instruction (S=1) the proper RSV Array (e.g., 105-113) may then reset the classification flag (S=0).

The operations that may be accomplished in the RSV Arrays 105-113 and those that need to be offloaded can vary depending on the implementation and system needs, and the above description of the segregation of those functions can vary as needs vary. Accordingly FIG. 2 should be considered as exemplary of one implementation for purposes of illustration, but is not limited to the implementation shown.

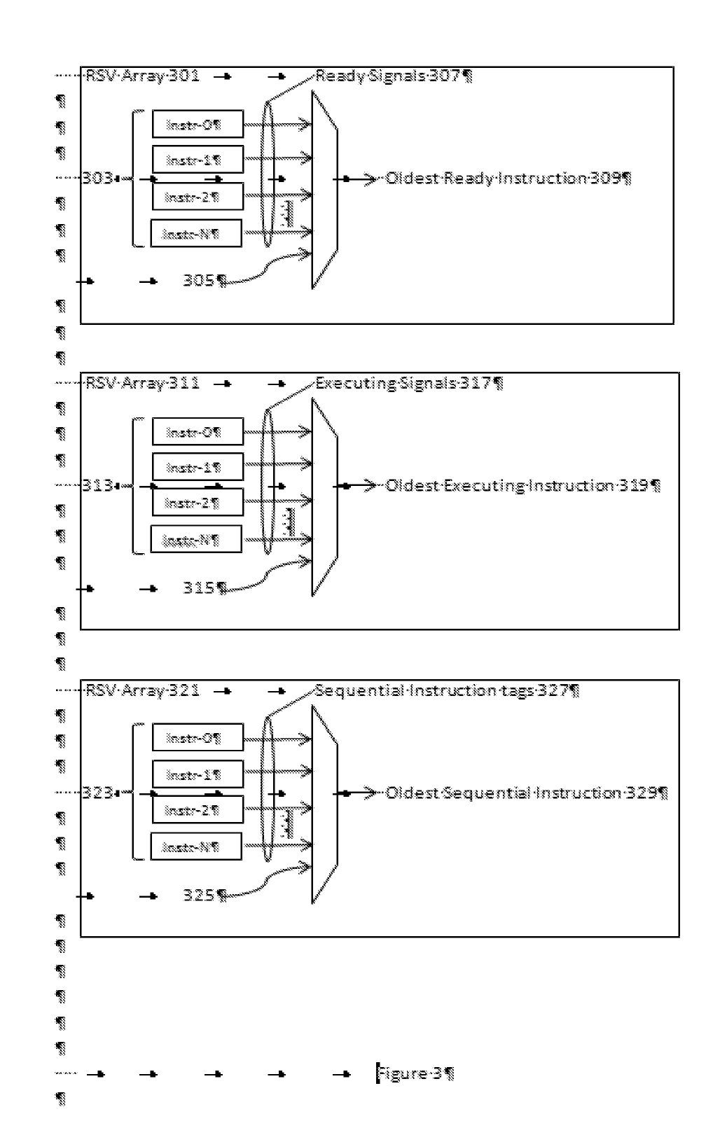

FIG. 3 is a graphic diagram illustrating different aspects of RSV arrays according to aspects of the invention.

RSV Array 301 illustrates an operational aspect of a typical instruction picker. A typical instruction picker has incoming ready signals 307 from a sequence of instructions 303. Ready signals 307 indicate whether an instruction is ready to execute and a priority mux 305 to select the oldest instruction that is ready 309.

According to one aspect of the current disclosure, in an exemplary implementation, the classification state (i.e. the S flag which accompanies instructions) can be used to prevent an instruction from being ready to execute by setting S=1, as illustrated with respect to RSV Array 321. A priority mux 325 receives Sequential Instruction Tags 327 (S=1) from a sequence of instructions 323 indicating that an instruction is classified as a Sequential Instruction, and uses the classification state (S=1) to determine the oldest Sequential Instructions 329. This information can used to unblock the oldest Sequential Instruction that is otherwise ready (i.e., not ready only because it was classified as a Sequential Instruction). This information can be used to enforce sequential order on instructions classified as a Sequential Instructions (S=1). When the oldest Sequential Instruction executes or is guaranteed to execute, that instruction's classification state is cleared, (S=0), to enable selection of the next oldest classified instruction. This enforces program-order pick of instructions classified as sequential, i.e., S=1.

Another solution to enforce program order is to prevent the picking of any instruction with the Sequential Instruction classification state. The classification state of the first in program order (and the hence the oldest) Sequential Instruction is cleared (S=0) when the instruction is ready to execute. When the current oldest Sequential Instruction has executed, or is assured to execute, the classification state of the next oldest classified instruction can be cleared (i.e. set S=0), allowing it to execute.

The above teachings may also be used in solving the “skip over instruction” problem according to aspects of the inventive concepts herein. The “skip over instruction” problem can occur when a Sequential Instruction exists in a branch of computer code that was not taken. Because the branch was not taken the Sequential Instruction in the not taken branch never executes and so younger Sequential Instruction's will not execute, waiting for the Sequential Instruction that was in the branch not taken to execute. The instruction will not execute because it will not be reached. Such a problem, if not solved, can deadlock the computer system as it waits for an event that will not occur.

Additionally, to solve the “skip over instruction” problem another mechanism, as illustrated in FIG. 3 with respect to RSV Array 311, may be used. Instructions 313 that are in the process of executing provide Executing Signals 317, indicating that an instruction is in the process of executing, to a priority mux 315 which identifies the Oldest Executing Instruction 319.

FIG. 3 illustrates 3 RSV Array components, though they may or may not be contained physically in the actual RSVs, which may be used to solve the “skip over instruction” problem.

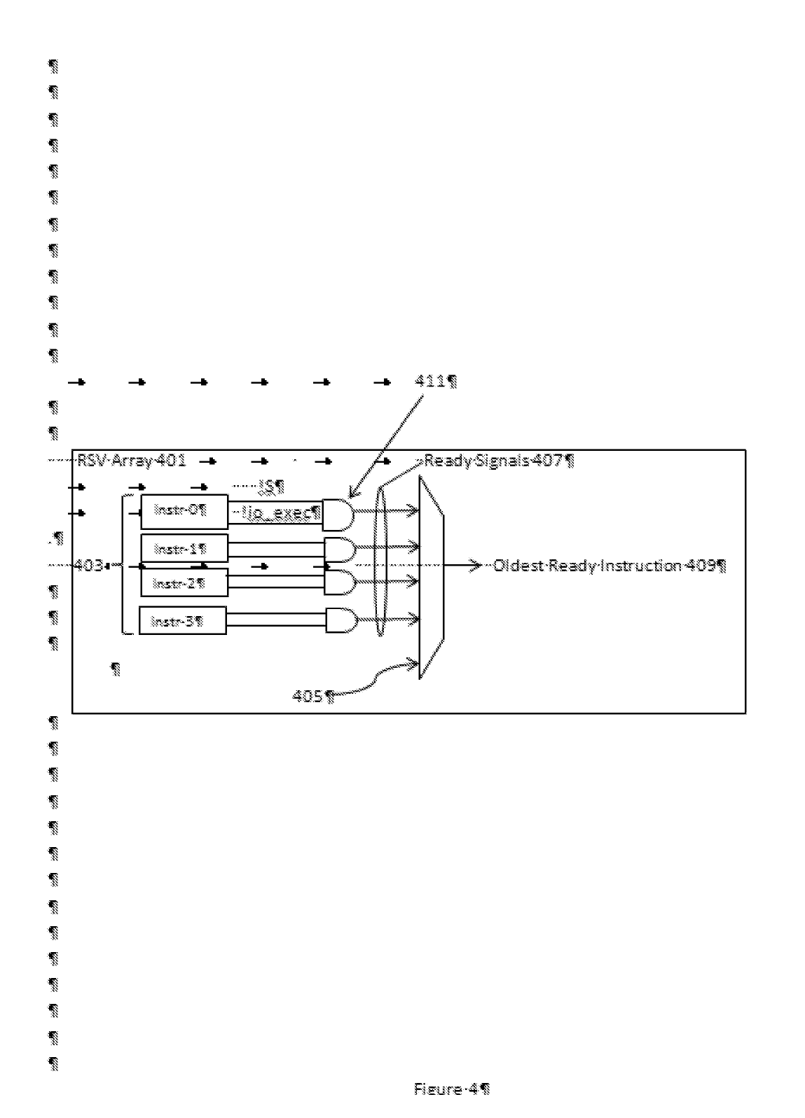

FIG. 4 is a graphic diagram illustrating an implementation of an RSV Array 401 according to aspects of the inventive concepts herein. The RSV Array 401 may be used to enforce program order by preventing execution of instructions marked as Sequential Instructions (S=1). When the current oldest Sequential Instruction has executed, or is assured to execute, the classification state (S) of the next oldest Sequential Instruction is cleared (S is set to 0) allowing it to execute. Instructions 403 provide a !S signal, that, if true, indicates that the instruction is either not a Sequential Instruction or that it is the oldest ready to execute Sequential Instruction that has had its S flag reset, so it is treated as an ordinary instruction. Additionally an !io_exec signal is anded, e.g. using and gate 411, with the !S signal. The !io_exec signal is a RSV Array signal and indicates if there are any Sequential Instructions present within the RSV Array 401. Anding the !S signal and the !io_exec signal indicates that the instruction is not a Sequential Instruction (!S) or that there are no Sequential Instructions present in the RSV Array (!io_exec) and a Ready Signal 407 is asserted. The priority mux 405 can receive the Ready Signals 407 and determine which is the Oldest Ready Instruction 409, which may then be executed.

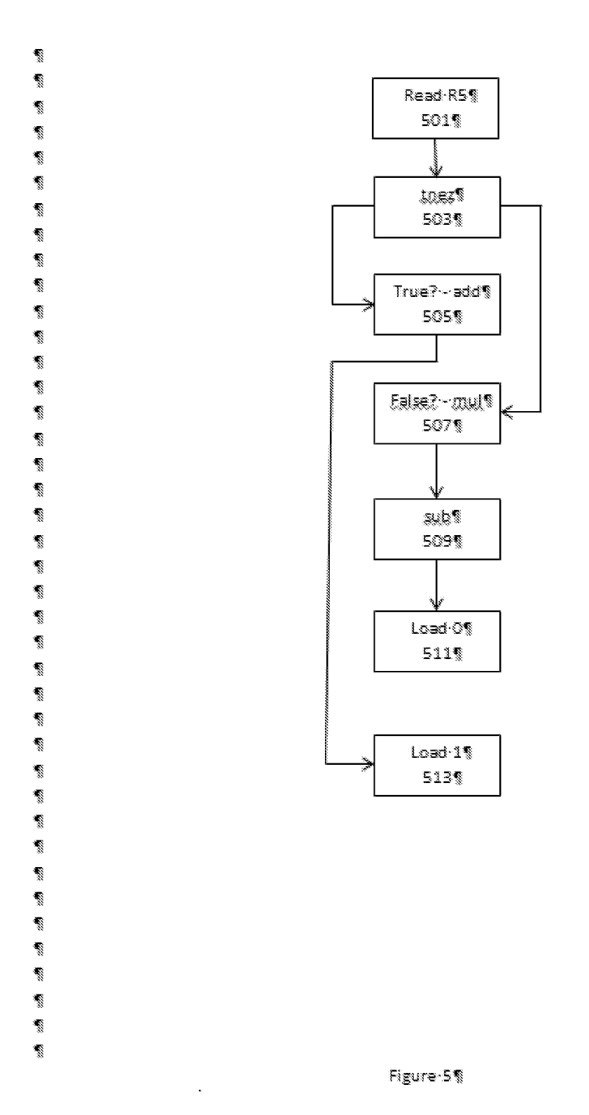

FIG. 5 is a flow chart illustrating the Sequential Instruction “skip over instruction” problem. The flow chart is a graphical representation of a computer program, in which a Load 0 instruction 511 precedes a Load 1 instruction 513. Both the Load 0 instruction 511 and the Load 1 instruction 513 are Sequential Instructions (S=1). Because of the program instruction order, in which the Load 0 instruction 511 precedes the Load 1 instruction 513, the Load 0 instruction 511 is considered to be younger than the Load 1 instruction 513. Because the Load 0 instruction 511 is considered to be younger than the Load 1 instruction 513 it needs to execute first.

In Block 501 Register R5 is read. Next in block 503 the contents of register R5 is tested to see if it is not equal to zero. A false result transfers control to a block 507 where a multiply is performed, then control is transferred to block 509 where a subtract is performed. Next the Load 0 instruction 511 is executed. However if the tnez (test if not equal to zero) instruction in block 503 results in a true then an add in Block 505 is performed and control is transferred to Load 1 instruction 513. However Load 1 instruction 513, cannot execute because it is a Sequential Instruction, which cannot execute because there is a younger Sequential Instruction, i.e. Load 0 instruction 511, which has not executed. Additionally, because the Load 0 instruction 511 is in a branch not taken of the flowchart, the program code will not execute. Because Load 0 instruction 511will not be executed, as it is in a branch not taken, it should be skipped over and not block the execution of an older Sequential Instructions (e.g. Load 1 instruction 513). What is needed is a way to identify Sequential Instructions that may be skipped. The Sequential Instruction may be skipped if the oldest executing instruction is younger than the oldest classified instruction. The Sequential Instruction may be also be skipped if the oldest-executing instruction is younger than the oldest Sequential Instruction.

Another way to determine if a Sequential Instruction may be skipped is to keep count of executing instructions. If the execution count is zero (or specifically execution count of all instructions older than the oldest Sequential Instruction is zero) and the oldest ready instruction is younger than the oldest Sequential Instruction, the oldest Sequential Instruction can be safely skipped over.

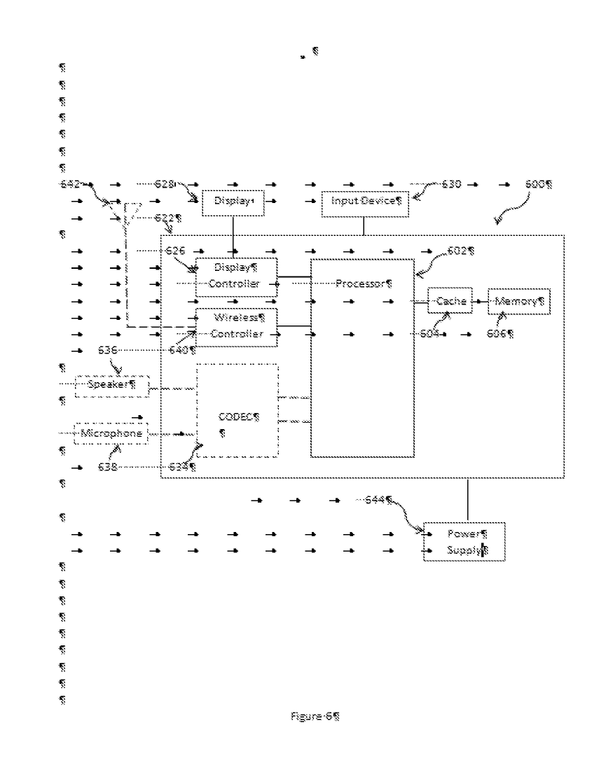

FIG. 6 is a graphical illustration of a computing device 600, which may advantageously employ the teachings herein to improve performance.

In FIG. 6, processor 602, is exemplarily shown to be coupled to memory 606 with cache 604 disposed between processor 602 and memory 606, but it will be understood that other configurations known in the art may also be supported by computing device 600. FIG. 6 also shows display controller 626 that is coupled to processor 602 and to display 628. In some cases, computing device 600 may be used for wireless communication and FIG. 6 also shows optional blocks in dashed lines, such as coder/decoder (CODEC) 634 (e.g., an audio and/or voice CODEC) coupled to processor 602 and speaker 636 and microphone 638 can be coupled to CODEC 634; and wireless antenna 642 coupled to wireless controller 640 which is coupled to processor 602. Where one or more of these optional blocks are present, in a particular aspect, processor 602, display controller 626, memory 606, and wireless controller 640 are included in a system-in-package or system-on-chip device 622.

Accordingly, in a particular aspect, input device 630 and power supply 644 are coupled to the system-on-chip device 622. Moreover, in a particular aspect, as illustrated in FIG. 6, where one or more optional blocks are present, display 628, input device 630, speaker 636, microphone 638, wireless antenna 642, and power supply 644 are external to the system-on-chip device 622. However, each of display 628, input device 630, speaker 636, microphone 638, wireless antenna 642, and power supply 644 can be coupled to a component of the system-on-chip device 622, such as an interface or a controller.

It should be noted that although Figure. 6 generally depicts a computing device, processor 602, cache 604 and memory 606, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for managing allocation of a cache. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method to serialize selection of a select group of instructions using an out of order instruction picker, the method comprising:
tagging instructions as belonging to the select group of instructions;
identifying a program order of the instructions belonging to the select group of instructions; and
executing the instructions belonging to the select group of instructions in program order.

2. The method of claim 1, further comprising untagging an instruction indicating that the instruction does not belong to the select group of instructions once the instruction executes or is guaranteed to execute.

3. The method of claim 1, wherein executing the instructions belonging to the select group of instructions in program order further comprises:
not selecting a tagged instruction to execute;
untagging the tagged instruction if it is the next oldest tagged instruction to be executed; and
executing the untagged instruction as if it had not been tagged.

4. The method of claim 3 wherein untagging the tagged instruction if it is the next oldest tagged instruction executed comprises:
executing an untagged instruction;
determining a next oldest tagged instruction; and
untagging the next oldest tagged instruction.

5. The method of claim 1, wherein the select group of instructions comprise Sequential Instructions.

6. An apparatus for executing Sequential Instructions, the apparatus comprising:
a decoder that identifies a select group of instructions and tags them;
a Reservation Station (RSV) that receives the tagged instructions into arrays for execution;
a multiplexer for receiving complex instructions from the arrays within the RSV and directing them to an appropriate Functional Unit; and
a multiplexer that receives a result from the appropriate Functional Unit and directs it to an appropriate array within the RSV.

7. The apparatus of claim 6 wherein the result from the appropriate Functional Unit comprises a result of the executed Sequential Instruction and a signal that confirms execution of the instruction so that the instruction may be untagged by the appropriate array within the RSV.

8. A method for executing Sequential Instructions, the method comprising:
identifying a select group of instructions;
tagging each instruction in the select group of instructions;
receiving the tagged instructions in a Reservation Station (RSV);
placing the tagged instruction in RSV Arrays for execution;
receiving complex instructions from the RSV Arrays within the RSV in a multiplexer;
directing the complex instructions to an appropriate Functional Unit;
receiving a result from the appropriate Functional Unit in a multiplexer; and
directing the result to an appropriate array within the RSV.

9. The method of claim 8 wherein the receiving a result from the appropriate Functional Unit in a multiplexer further comprises:
providing an indication of the execution of the instruction; and
untagging the instruction by the appropriate array within the RSV.

10. A method of skipping execution of a Sequential Instruction, the method comprising:
detecting a Sequential Instruction in a branch not taken of computer code; and
untagging the Sequential Instruction.

11. A method of skipping execution of a Sequential Instruction, the method comprising:
detecting an oldest ready instruction;
detecting an oldest Sequential Instruction;
determining that the oldest ready instruction is younger that the oldest Sequential Instruction; and
allowing the oldest Sequential Instruction to be skipped.

12. The method of claim 11 wherein allowing the oldest Sequential Instruction to be skipped comprises resetting the tag of the oldest Sequential Instruction.

13. The method of claim 11 wherein detecting the oldest ready instruction comprises:
coupling a ready signal from each instruction in an RSV Array into a priority multiplexer; and
using the priority multiplexer to determine which ready instruction is the oldest.

14. The method of claim 11 wherein detecting the oldest Sequential Instruction comprises:
coupling a Sequential Instruction tag from each instruction in an RSV Array into a priority multiplexer; and
using the priority multiplexer to determine which Sequential Instruction is the oldest.

15. A method of skipping execution of a Sequential Instruction, the method comprising:
detecting an oldest executing instruction;
detecting an oldest Sequential Instruction;
determining that the oldest executing instruction is younger that the oldest Sequential Instruction; and
allowing the oldest Sequential Instruction to be skipped.

16. The method of claim 15 wherein allowing the oldest Sequential Instruction to be skipped comprises resetting the tag of the oldest Sequential Instruction.

17. The method of claim 15 wherein detecting the oldest Sequential Instruction comprises:
coupling a Sequential Instruction tag from each instruction in an RSV Array into a priority multiplexer; and
using the priority multiplexer to determine which Sequential Instruction is the oldest.

18. The method of claim 15, where detecting the oldest executing instruction comprises:
coupling a signal indicating that an instruction is executing from each instruction in an RSV Array into a priority multiplexer; and
using the priority multiplexer to determine which executing instruction is the oldest.

19. A method of skipping execution of a Sequential Instruction, the method comprising:
keeping an execution count of a number of executing instructions within an RSV Array;
determining an oldest Sequential Instruction in the RSV Array;
determining an oldest ready instruction in the RSV Array;
determining if an execution count of all instructions older than the oldest Sequential Instruction is zero and the oldest ready instruction is younger than the oldest Sequential Instruction; and
allowing the oldest Sequential Instruction to be skipped if the execution count of all the instructions older than the oldest Sequential Instruction is zero and the oldest ready instruction is younger than the oldest Sequential Instruction.

20. The method of claim 19 wherein allowing the oldest Sequential Instruction to be skipped comprises resetting the tag of the oldest Sequential Instruction.
